(19) United States
(12) Patent Application Publication
(10) Pub. No.: US 2009/0128471 A1
(43) Pub. Date: May 21, 2009

(54) Integrated driving board and liquid crystal display module having the same

(75) Inventors: Chien-Chung Hsiao, Hsinchu (TW); Wei-Jen Chou, Hsinchu (TW); Bor-Jyh Pan, Hsinchu (TW)

Correspondence Address: BACON & THOMAS, PLLC, 625 SLATERS LANE, FOURTH FLOOR, ALEXANDRIA, VA, 22314-1176, US

(73) Assignee: Young Lighting Technology Corporation, Hsinchu (TW)

(21) Appl. No.: 12/153,912

(22) Filed: May 28, 2008

(30) Foreign Application Priority Data
Nov. 15, 2007 (TW) 096143149

(51) Int. Cl. G09G 3/36

(52) U.S. Cl. 345/88

(57) ABSTRACT

A liquid crystal display module and an integrated driving board thereof are disclosed. The driving board includes a substrate, a circuit pattern, a timing clock driver, a light emitting diode (LED) driving module, a color management module and a photosensitive chip. The circuit pattern is disposed on the surface of the substrate. The timing clock driver, the LED driving module, the color management module and the photosensitive chip are disposed on the substrate and electrically coupled to the circuit pattern. The LED driving module is electrically coupled to the timing clock driver. The color management module is electrically coupled to the LED driving module. The photosensitive chip is electrically coupled to the color management module.

### BACKGROUND OF THE INVENTION

(1) Field of the Invention

The present invention relates to an integrated driving board, and more particularly relates to an integrated driving board applied in a liquid crystal display module.

(2) Description of the Prior Art

Traditionally, an inverter was separated from a liquid crystal display (LCD) module when CCFL was used as light source of notebook computer or LCD module. That is, panel maker would provide the LCD module and system maker then combined the LCD module and the inverter together. However, as for the LCD module which uses red, green, blue light emitting diode (LED) as light source, a color management system is needed besides the LED driver. Therefore, the panel maker need also provide the color management system and the LED driver.

Refer to FIGS. 1A and 1B for the front and back schematic view of the LCD module with LED as light source. A LCD module 100 includes a liquid crystal display panel 120 and a backlight module 140. A LED driving board 160, a T-con board 180 and a color management system 110 are required to drive the liquid crystal display panel 120 and the backlight light module 140. A light source 142 of the backlight module 140 has a plurality of LEDs (not shown). The color management system 110 includes a color feed back control chip 112 and a color sensor 114. The color feed back control chip 112 is disposed on the LED driving board 160. Connections (not shown) like wire, flexible flat cable (FFC) or a flexible print circuit board (FPC) are used between the LED driving board 160 and the light source 142 as well as the LED driving board 160 and the color sensor 114. Then the LED driving board 160 and the T-con board 180 are connected with a system board 130 by two connections respectively.

The color management system 110 and the LED driving board 160 are designed in separation. The color management system 110 and the LCD module 100 are also designed separately, but matched with each other. Too many separated components will cause excessive wires of the LCD module 100 and complicated assembly. As for the system maker, the degree of freedom for assembly design is rather low.

In addition, it is acceptable for LCD TV and LCD monitor that the LED driving board 160 and the color management system 110 are assembled on the backlight module 140, but for thin notebook computer, the location should be appropriate for the best thickness. It also makes the LED driving board 160 designed with less freedom, which will affect the structure design.

### SUMMARY OF THE INVENTION

The present invention is to provide an integrated driving board for a liquid crystal display (LCD) module, with less connection wires and more freedom for space design of the LCD module in assembly.

For one or part of or all objectives mentioned or other objectives, one embodiment of the present invention is an integrated driving board. The integrated driving board includes a substrate, a circuit pattern, a timing clock driver, a light emitting diode (LED) driving module, a color management module and a photosensitive chip. The substrate has a surface. The circuit pattern is laid on the surface of the substrate. The timing clock driver is electrically coupled to the circuit pattern and fixed on the substrate. The LED driving module is fixed on the substrate and electrically coupled to the circuit pattern, so as to electrically conduct the LED driving module with the timing clock driver. The color management module is fixed on the substrate and electrically coupled to the circuit pattern, so as to electrically conduct the color management module with the LED driving module. The photosensitive chip is fixed on the substrate and electrically coupled to the circuit pattern, so as to electrically conduct the photosensitive chip with the color management module.

According to another embodiment of the present invention, a liquid crystal display module includes a liquid crystal display panel, an abovementioned integrated driving board, a first connection wire, a second connection wire, a backlight module and a system board. The first connection wire is electrically coupled to the LED driving module of the integrated driving board. The second connection wire is electrically coupled to the timing clock driver of the integrated driving board. The backlight module is electrically coupled to the first connection wire. The system board is electrically coupled to the second connection wire.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIGS. 1A and 1B is a schematic view of the conventional liquid crystal display module;

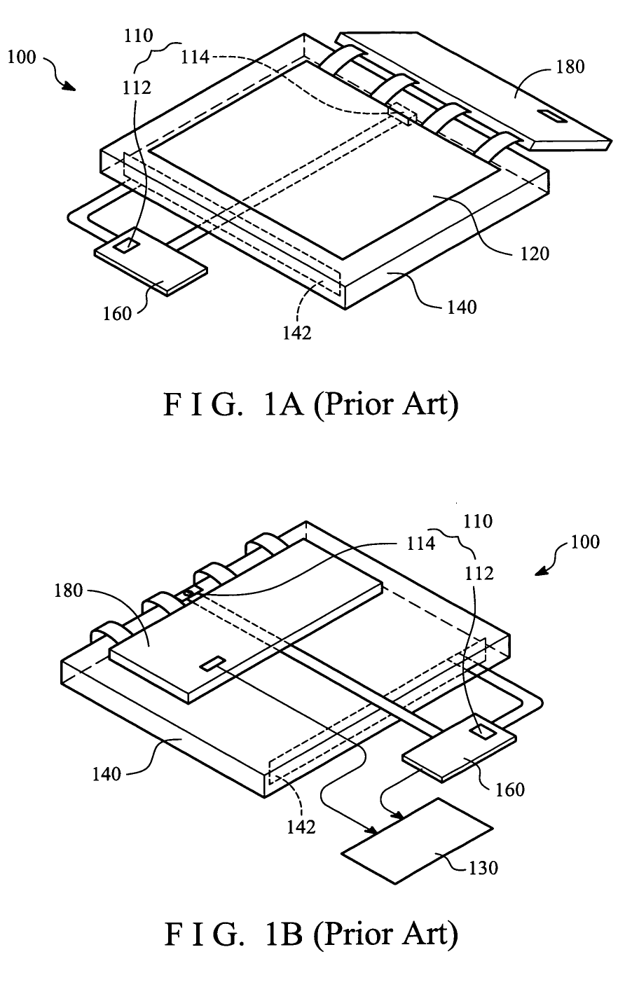

FIG. 2 is a circuit diagram of an integrated driving board according to one embodiment of the present invention;

FIGS. 3A and 3B is a front and back view of a liquid crystal display module according to one embodiment of the present invention; and

FIGS. 4A and 4B is a schematic view of the liquid crystal display module according to one embodiment of the present invention, wherein the backlight module and the color sensor are assembled.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

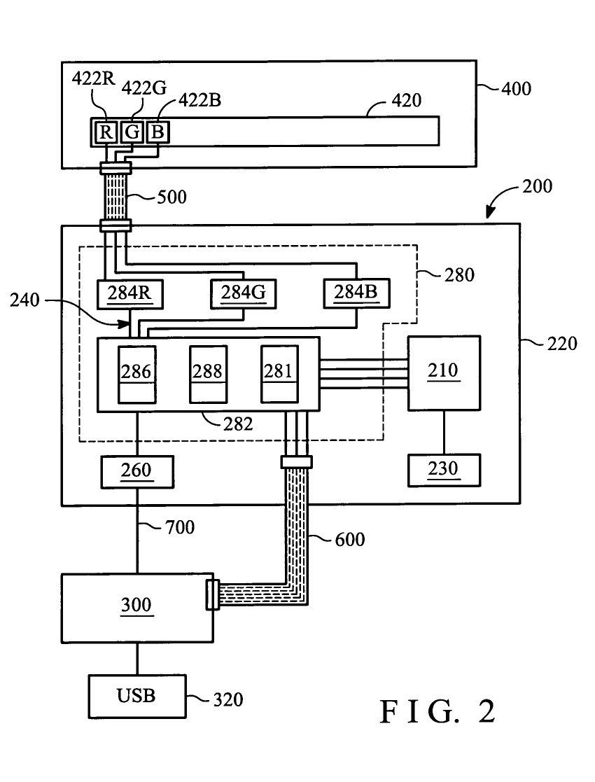

Refer to FIG. 2 for the circuit diagram of an integrated driving board 200 according to one embodiment of the present invention, which shows the electrical coupling relationship of the integrated driving board 200, a system board 300 and a backlight module 400. The integrated driving board 200 includes a substrate 220, a circuit pattern 240, a timing clock driver 260, a light emitting diode (LED) driving module 280, a color management module 210 and a photosensitive chip 230.

The substrate 220 has a surface. The circuit pattern 240 is disposed on the surface of the substrate 220 with a plurality of joints (not shown), which are used for the connections of the timing clock driver 260, the LED driving module 280, the color management module 210 and the photosensitive chip 230 mentioned above. The ways of connection may be jointing or all kinds of methods known in the art.

Referring to FIG. 2 for example, the color management module 210, the photosensitive chip 230 and the timing clock driver 260 are all disposed on the substrate 220, electrically coupled to the circuit pattern 240, and each takes a joint of the circuit pattern 240. The LED driving module 280 may includes a plurality of circuit components, for example, in one preferred embodiment, the LED driving module 280 includes a microcontroller 282 and is electrically coupled to a boost converter 284R, 284B or 284G for at least a red, blue and green LED. These circuit components are also fixed on the substrate 220, electrically coupled to the circuit pattern 240, and take four joints of the circuit pattern 240.

In this way, the timing clock driver 260, the LED driving module 280, the photosensitive chip 230 and the color management module 210 are all disposed on the substrate 220, electrically conducted with each other by the circuit pattern 240. For example, in this embodiment, the LED driving module 280 and the timing clock driver 260 are electrically conducted with each other. The color management module 210 and the LED driving module 280 are electrically conducted with each other. The photosensitive chip 230 and the color management module 210 are electrically conducted with each other.

The substrate 220 of the integrated driving board 200 and the circuit pattern 240 may be regarded as a single layer or multilayer press circuit board, which means the circuit pattern 240 may be formed by etching the surface copper layer of the copper board if provided.

The backlight module 400 has a light bar 420, which includes at least a red, blue and green LED 422R, 422B, 422G. The LED 422R, 422B and 422G are electrically coupled to the LED driving module 280 through a connection wire 500.

In addition, the timing clock driver 260, the LED driving module 280, the color management module 210 and the photosensitive chip 230 may be a single function integration chip or a group consisting of a plurality of circuit components. For example, the above-mentioned LED driving module 280, the microcontroller 282 and the boost converter 284R, 284B, 284G may be integrated into a single chip, taking only one joint of the circuit pattern 240; or dispersedly fixed in the plural joints of the circuit pattern 240. The microcontroller 282 includes an electrically-erasable programmable read-only memory (EEPROM) 286, an analog-to-digital converter (ADC) 288 and an inter-integrated circuit (12C) command 281.

As shown in FIG. 2, the microcontroller 282 is electrically coupled to the timing clock driver 260 and the color management module 210. The color management module 210 and the microcontroller 282 may communicate with each other by serial communication signals. Moreover, the color management module 210 is electrically coupled to the photosensitive chip 230.

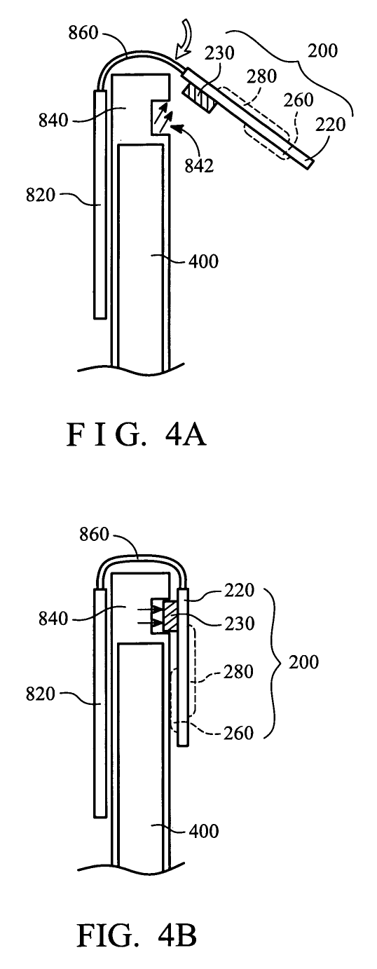

The boost converter 284R, 284B and 284G of the red, blue and green LED 422R, 422B, 422G are electrically coupled to the light bar 420 of the backlight module 400 through a connection wire 500. The photosensitive chip 230 is combined with the backlight module 400, referring to the FIGS. 4A and 4B. When the photosensitive chip 230 detects the brightness of the backlight module 400, it sends the brightness value to the color management module 210. The color management module 210 then have a feedback control to the boost converter 284R, 284B and 284G of the red, blue and green LED 422R, 422B, 422G. The boost converter 284R, 284B, 284G control the LED 422R, 422B, 422G respectively. In this way, the color domain, the brightness and light distribution of the backlight module 400 are adjusted.

The timing clock driver 260 is the control chip of the liquid crystal display panel (not shown), which may support a lot of input and output standards, including LVDS RSDS and mini-LVDS. When the timing clock driver 260 receives image data, it generates control sequence to control the source driver and gate driver of the liquid crystal display panel (LCD panel). The image data are transferred to the LCD panel for display in this way.

The system board 300 is electrically coupled to the microcontroller 282 and the timing clock driver 260 of the integrated driving board 200. The system board 300 is conducted with the microcontroller 282 through a connection wire 600, which supports serial data transmission preferably. The system board 300 is conducted with the timing clock driver 260 through a connection wire 700, which prefers to be LVDS. In addition, the system board 300 has a USB port 320. The above-mentioned connection wire 500,600 and 700 may be gold wire, flexible flat cable (FFC) or a flexible print circuit board (FPC).

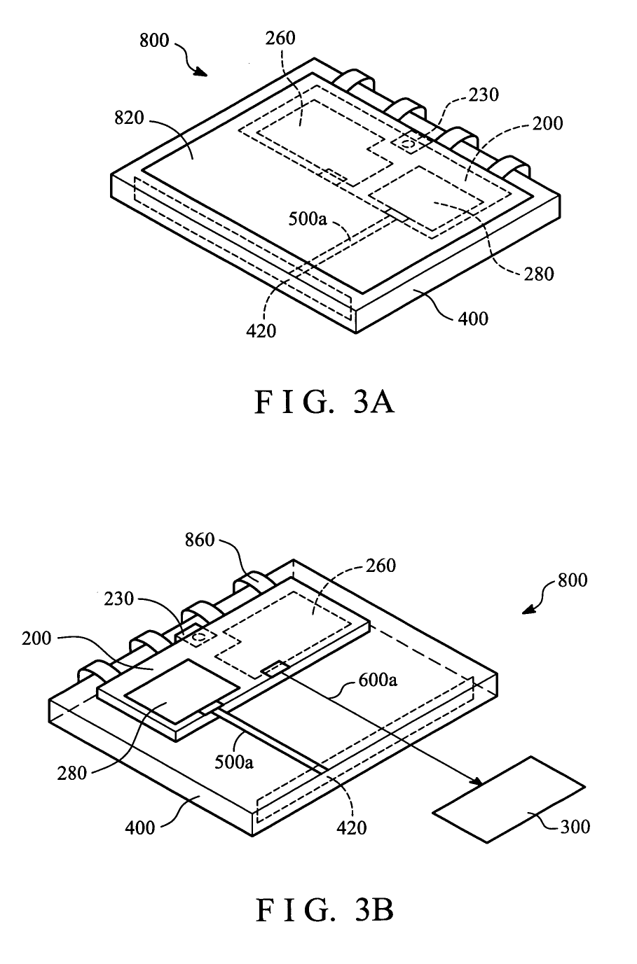

Referring to the FIGS. 3A and 3b, it is a front and back view of a LCD module 800. The LCD module 800 includes a LCD panel 820, the above-mentioned integrated driving board 200, a first connection wire 500a, a second connection wire 600a, the above-mentioned backlight module 400 and the system board 300. One end of the first connection wire 500a is electrically coupled to the LED drive module 280 of the integrated driving board 200, the other end coupled to the light bar 420 of the backlight module 400. One end of the second connection wire 600a is electrically coupled to the timing clock driver 260 of the integrated driving board 200, the other end coupled to the system board 300.

Referring to a preferable embodiment of FIG. 3B, the integrated driving board 200 is electrically coupled to a plurality of flexible print circuit boards 860, which are electrically coupled to the LCD panel 820. The electrical connection of the LED driving module 280 and the timing clock driver 260 may be laid out directly on the substrate 220. Thus, only the first and second connection wire 500a, 600a are needed, such as gold wire, FFC or FPC, one connected to the light bar 420 of the backlight module 400, the other to the system board 300, acting as the input and control of the power source and electrical signal. In this way, the layout and the connections of the components can be simplified. The LCD module 800 can be integrated as a single module with brightness and chroma control.

Referring to FIGS. 4A and 4B, the LCD module 800 also includes a frame 840 having a photosensitive gap 842 corresponding to the photosensitive chip 230 of the integrated driving board 200. When the integrated driving board 200 is shifted next to the back of the backlight module 400, because the three filters of the photosensitive chip 230 of the integrated driving board 200 are matched with the photosensitive gap 842, they are caught straightly into the photosensitive gap 842. The photosensitive chip 230 is used to detect the present energy, brightness and chroma.

The photosensitive chip 230 is directly mounted on the side of the backlight module 400 of the substrate 220 of the integrated driving board 200, which may be located in the photosensitive gap 842 of the frame 840. The photosensitive gap 842 has a cavity to seal and place the photosensitive chip 230. The photosensitive chip 230 may detect the light energy and chroma in the cavity or from the light guide plate (not shown). In this way, the chroma and the brightness errors may be considered together at the same time as LCD panel 820 and the backlight module 400 are combined.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An integrated driving board, applied to a liquid crystal display module, comprising:
a substrate, having a surface;
a circuit pattern, laid on the surface of the substrate;
a timing clock driver, electrically coupled to the circuit pattern and fixed on the substrate;
a light emitting diode driving module, fixed on the substrate and electrically coupled to the circuit pattern, so as to electrically conduct the light emitting diode driving module with the timing clock driver;
a color management module, fixed on the substrate and electrically coupled to the circuit pattern, so as to electrically conduct the color management module with the light emitting diode driving module; and
a photosensitive chip, fixed on the substrate and electrically coupled to the circuit pattern, so as to electrically conduct the photosensitive chip with the color management module.

2. The integrated driving board of claim 1, wherein the light emitting diode driving module comprises a microcontroller and at least a red, a blue and a green light emitting diode boost converters.

3. The integrated driving board of claim 2, wherein the microcontroller of the light emitting diode driving module comprises an electrically-erasable programmable read-only memory, an analog-to-digital converter and an inter-integrated circuit command.

4. A liquid crystal display module, comprising:
a liquid crystal display panel;
an integrated driving board, comprising a substrate, a circuit pattern laid on the substrate, a timing clock driver electrically coupled to the liquid crystal display panel, a light emitting diode driving module, a photosensitive chip and a color management module, wherein the timing clock driver, the light emitting diode driving module, the photosensitive chip and the color management module are all electrically coupled to the circuit pattern and fixed on the substrate;
a first connection wire, electrically coupled to the light emitting diode driving module of the integrated driving board;
a second connection wire, electrically coupled to the timing clock driver of the integrated driving board;
a backlight module, electrically coupled to the first connection wire; and
a system board, electrically coupled to the second connection wire.

5. The liquid crystal display module of claim 4 further comprising a frame having a photosensitive gap corresponding to the photosensitive chip of the integrated driving board.

6. The liquid crystal display module of claim 4 further comprising a plurality of flexible print circuit boards, wherein the integrated driving board is electrically coupled to the plural flexible print circuit boards and the plural flexible circuit boards are electrically coupled to the liquid crystal display panel.

7. The liquid crystal display module of claim 4, wherein the light emitting diode driving module is electrically coupled to the timing clock driver.

8. The liquid crystal display module of claim 4, wherein the color management module is electrically coupled to the light emitting diode driving module.

9. The liquid crystal display module of claim 4, wherein the photosensitive chip is electrically coupled to the color management module.

10. The liquid crystal display module of claim 4, wherein the backlight module comprises at least a red, a blue and a green light emitting diodes.

11. The liquid crystal display module of claim 4, wherein each of the first and second connection wires is a flexible flat cable or a flexible print circuit board.
